(19) United States
(12) Patent Application Publication
(10) Pub. No.: US 2026/0268775 A1
(43) Pub. Date: Sep. 10, 2026

(54) EXTERNAL WORLD INFORMATION PROCESSING DEVICE AND EXTERNAL WORLD INFORMATION PROCESSING METHOD

(71) Applicant: Astemo, Ltd., Chiyoda-ku, Tokyo (JP)

(72) Inventor: Yuichi KOMORIYA, Hitachinaka-shi, Ibaraki (JP)

(73) Assignee: Astemo, Ltd., Chiyoda-ku, Tokyo (JP)

(21) Appl. No.: 19/163,659

(22) PCT Filed: May 29, 2023
(86) PCT No.: PCT/JP2023/019989

§ 371 Date: Sep. 9, 2025

(51) Int. Cl. G08G 1/16; G08G 1/0967

(52) U.S. Cl. CPC G08G 1/166; G08G 1/096766

(57) ABSTRACT

An external world information acquisition unit that acquires external world information around an own vehicle on the basis of a result recognized by an external world recognition unit, a visible region acquisition unit that acquires a visible region as a travelable region visible from the own vehicle on the basis of the external world information, an oncoming vehicle state determination unit that determines a state of the oncoming vehicle on the basis of the visible region and information on a behavior of the oncoming vehicle, a blind region acquisition unit that acquires a blind region that is a blind spot of the own vehicle on the basis of the state of the oncoming vehicle, the visible region, and a position of the oncoming vehicle acquired based on the external world information, and a virtual evacuation region acquisition unit that acquires a virtual evacuation region for the own vehicle and the oncoming vehicle to pass each other based on the visible region and the blind region are provided.

### TECHNICAL FIELD

The present invention relates to an external world information processing device and an external world information processing method for processing external information of its own vehicle.

### BACKGROUND ART

Conventionally, a technique for supporting passing-each-other of own vehicle and another vehicle on a narrow road has been proposed. For example, Patent Literature 1 discloses detecting an evacuation space which is a space where a vehicle can evacuate on the basis of map data, generating evacuation space information which is information regarding the detected evacuation space and is used for setting an evacuation route for evacuating the vehicle to pass an oncoming vehicle, and controlling passing of the oncoming vehicle.

### CITATION LIST

### Patent Literature

PTL 1: WO 2018-198186 A

### SUMMARY OF INVENTION

### Technical Problem

In the conventional technique, when the evacuation region cannot be recognized, the own vehicle moves backward to the evacuation region registered in advance. However, when the own vehicle does not move backward, even if there is an evacuation region in the traveling direction of the own vehicle, the evacuation region cannot be detected by recognition by sensing, and a situation occurs in which both vehicles stand by and cannot pass each other.

In a case where there is an evacuation region on a road that has been traveled once, there is a method for registering the evacuation region in a map and allowing the own vehicle to move to the evacuation region. On the other hand, in a case where the evacuation region information is not registered in the map, it is necessary to determine the evacuation region by external world recognition by a distance measuring sensor or an image recognition sensor. However, the external world recognition has a problem that although the evacuation region actually exists, the evacuation region cannot be recognized due to the size (upper limit) of the visual field of each sensor, the current position of the own vehicle, and the blind spot caused by the structure, and it is determined that the evacuation region does not exist.

From the above situation, there has been a demand for a method for realizing smooth passing-each-other when the own vehicle cannot find the evacuation region in a situation where the own vehicle and the oncoming vehicle are required to pass each other.

### Solution to Problem

In order to solve the above problem, an external world information processing device according to an aspect of the present invention includes: an external world information acquisition unit that acquires external world information around an own vehicle on the basis of a result recognized by the external world recognition unit; a visible region acquisition unit that acquires a visible region as a travelable region visible from the own vehicle on the basis of the external world information; an oncoming vehicle state determination unit that determines a state of an oncoming vehicle on the basis of the visible region and information regarding behavior of the oncoming vehicle; a blind region acquisition unit that acquires a blind region that is a blind spot of the own vehicle on the basis of the state of the oncoming vehicle, the visible region, and a position of the oncoming vehicle acquired on the basis of the external world information; and a virtual evacuation region acquisition unit that acquires a virtual evacuation region for the own vehicle and the oncoming vehicle to pass each other on the basis of the visible region and the blind region.

### Advantageous Effects of Invention

According to at least one aspect of the present invention, when the own vehicle cannot find the evacuation region in a situation where the own vehicle and the oncoming vehicle are required to pass each other, it is possible to reduce a deadlock state and realize smooth passing-each-other by estimating the evacuation region.

Problems, configurations, and effects other than those described above will be clarified by the following description of embodiments.

### BRIEF DESCRIPTION OF DRAWINGS

FIG. 1 is a block diagram illustrating a functional configuration example of a vehicle control device including an external world information processing device according to a first embodiment of the present invention.

FIG. 2 is a block diagram illustrating a hardware configuration example of a control system of an external world information processing device and a travel control planning device constituting a vehicle control device.

FIG. 3 is a diagram illustrating an example of a passing-each-other traveling scene.

FIG. 4 is a flowchart illustrating a procedure example of processing of the external world information processing device according to the first embodiment of the present invention.

FIG. 5 is a schematic diagram illustrating an example of a visible region map.

FIG. 6 is a schematic diagram illustrating an example of a scene where passing-each-other is impossible.

FIG. 7 is a flowchart illustrating an example of a procedure example of processing of an oncoming vehicle state determination unit of the external world information processing device according to the first embodiment of the present invention.

FIG. 8 is a diagram illustrating an example of a blind region acquired by a blind region acquisition unit of the external world information processing device according to the first embodiment of the present invention.

FIG. 9 is a schematic diagram illustrating an example of a virtual evacuation region map acquired by a virtual evacuation region acquisition unit of the external world information processing device according to the first embodiment of the present invention.

FIG. 10 is a block diagram illustrating a functional configuration example of a vehicle control device including an external world information processing device according to a second embodiment of the present invention.

FIG. 11 is a diagram illustrating an example in which a blind region acquisition unit of an external world information processing device according to the second embodiment of the present invention acquires a blind region map on the basis of a travelable region recognized by an oncoming vehicle.

FIG. 12 is a schematic diagram illustrating an example of a virtual evacuation region map acquired by a virtual evacuation region acquisition unit of an external world information processing device according to the second embodiment of the present invention.

FIG. 13 is a schematic diagram illustrating a countermeasure example in a case where a blind region cannot be acquired by a blind region acquisition unit of an external world information processing device according to a third embodiment of the present invention.

### DESCRIPTION OF EMBODIMENTS

Hereinafter, examples of modes for carrying out the present invention (hereinafter, referred to as “embodiments”) will be described with reference to the accompanying drawings. In the present specification and the accompanying drawings, the same components or components having substantially the same function are denoted by the same reference numerals, and redundant description is omitted. Note that, as a premise, even in a system that can obtain map information, such as a road guidance system (so-called navigation system), it is assumed that there is no information on the evacuation region in the map information.

### First Embodiment

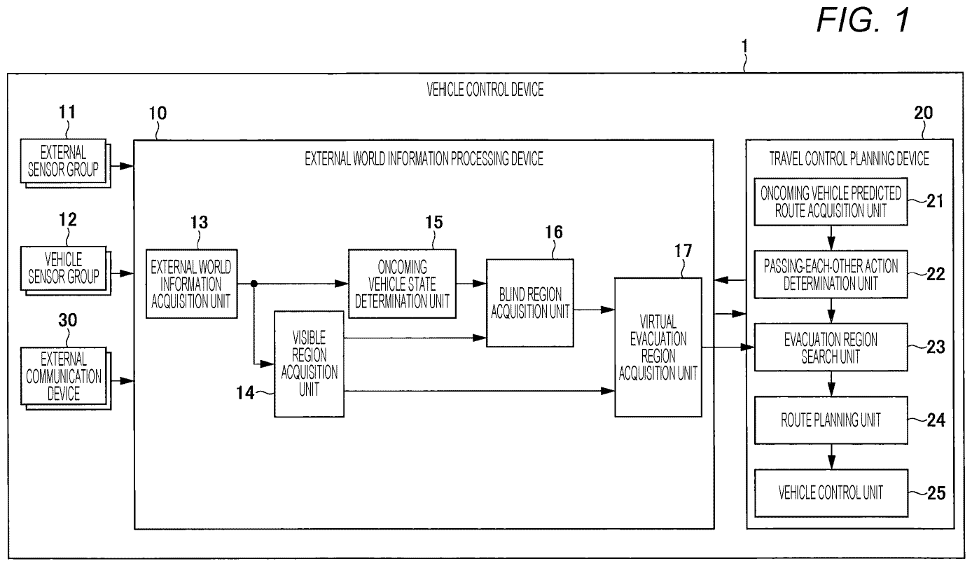

First, a vehicle control device including an external world information processing device according to a first embodiment of the present invention will be described with reference to FIGS. 1 to 9.

### [Configuration of Vehicle Control Device]

FIG. 1 is a block diagram illustrating a functional configuration example of a vehicle control device including an external world information processing device according to the first embodiment of the present invention. A vehicle control device 1 illustrated in FIG. 1 recognizes a road around the own vehicle and obstacles such as surrounding vehicles and pedestrians, and then performs appropriate driving assistance and travel control. The vehicle control device 1 includes an external sensor group 11, a vehicle sensor group 12, an external communication device 30, an external world information processing device 10, and a travel control planning device 20.

### (External World Information Processing Device)

The external world information processing device 10 includes an external world information acquisition unit 13, a visible region acquisition unit 14, an oncoming vehicle state determination unit 15, a blind region acquisition unit 16, and a virtual evacuation region acquisition unit 17.

The external world information acquisition unit 13 acquires various types of information as external world information of the own vehicle from the external sensor group 11. The external sensor (an example of the external world recognition unit) is, for example, a monocular camera, a stereo camera, a multi-camera, or a radar device. The various types of information include, for example, peripheral vehicle information such as a distance from the own vehicle to a peripheral vehicle, a speed of the peripheral vehicle, and a width of the peripheral vehicle detected by the external sensor group 11, lane information on a road, and the like. In addition to the external sensor group 11, the external world information acquisition unit 13 may acquire information detected in the other vehicle from the other vehicle by vehicle-to-vehicle communication (communication between the own vehicle and the other vehicle) by wireless communication using the external communication device 30.

The visible region acquisition unit 14 generates (acquires) travelable region information (also referred to as free space) indicating whether there is no obstacle or the like on the current road, blind region information indicating whether there is a blind region due to an obstacle or the like, obstacle information indicating whether there is an obstacle on the road, and the like on the basis of the various types of information acquired by the external world information acquisition unit 13. Then, the visible region acquisition unit 14 generates information on the visible region by combining the travelable region information, the blind region information, and the obstacle information. For example, the visible region information can be expressed by a grid-like map, and can be realized by using an occupancy grid map (OGM) as an example. Hereinafter, the information of the visible region indicated by the grid-like map representation is referred to as a “visible region map”.

The oncoming vehicle state determination unit 15 determines the state of the oncoming vehicle, that is, whether the oncoming vehicle is waiting for passing the own vehicle, based on the vehicle information (behavior) of the oncoming vehicle (moving object) existing in front (traveling direction) of the own vehicle acquired by the external world information acquisition unit 13. For example, the information regarding the behavior of the oncoming vehicle can be acquired on the basis of the external world information obtained by the external world information acquisition unit 13 from the external sensor group 11. It goes without saying that the present invention is also applicable to a case where the own vehicle passes a vehicle present in a traveling direction when the own vehicle travels backward (moves backward).

The blind region acquisition unit 16 estimates (acquires) a blind region where the temporary visible region in the present embodiment expands based on the information on the oncoming vehicle state acquired by the oncoming vehicle state determination unit 15, the travelable region information, the blind region information, the obstacle information, and the like acquired by the visible region acquisition unit 14, and the position of the oncoming vehicle acquired based on the external world information. It is desirable that the blind region acquisition unit 16 generate, as the blind region, a grid-like map representation having the same size as the visible region map generated by the visible region acquisition unit 14. By adjusting the size, the subsequent processing of generating the virtual evacuation region becomes simple. The blind region generated by the blind region acquisition unit 16 is a travelable region estimated by the action of the oncoming vehicle. Furthermore, in this case, the grid-like map representation has at least information of the blind region. However, similarly to the above-described visible region, obstacle information and the like as to whether there is an obstacle on the road may be included. Hereinafter, the information of the blind region indicated by the grid-like map representation is referred to as a “blind region map”.

The virtual evacuation region acquisition unit 17 combines the current visible region acquired by the visible region acquisition unit 14 and the blind region estimated by the blind region acquisition unit 16, estimates (acquires) a region that is a blind region of the visible region as a virtual evacuation region that is a region where evacuation can be performed, and outputs the virtual evacuation region to an evacuation region search unit 23 of the travel control planning device 20. It is desirable that the virtual evacuation region acquisition unit 17 generate a grid-like map representation having the same size as the visible region map generated by the visible region acquisition unit 14 as the virtual evacuation region. Hereinafter, the information of the virtual evacuation region indicated by the grid-like map representation is referred to as a “virtual evacuation region map”.

### (Travel Control Planning Device)

The travel control planning device 20 is a device that determines an action of the own vehicle from a travel environment, makes a travel control plan, and controls travel of the vehicle. The travel control planning device 20 has a function of updating map data around the own vehicle in accordance with movement of the own vehicle. As illustrated in FIG. 1, the travel control planning device 20 includes an oncoming vehicle predicted route acquisition unit 21, a passing-each-other action determination unit 22, an evacuation region search unit 23, a route planning unit 24, and a vehicle control unit 25. The travel control planning device 20 can be realized using a known technique.

The oncoming vehicle predicted route acquisition unit 21 predicts a traveling route (future oncoming vehicle track) of the oncoming vehicle based on the oncoming vehicle information acquired from the external world information acquisition unit 13.

The passing-each-other action determination unit 22 determines whether or not the oncoming vehicle intends to pass the own vehicle from a visible region map 106 acquired by the visible region acquisition unit 14 and the predicted track of the oncoming vehicle acquired by the oncoming vehicle predicted route acquisition unit 21. In other words, when the oncoming vehicle intends to pass the own vehicle, the passing-each-other action determination unit 22 determines that the own vehicle needs to perform passing-each-other in cooperation with the oncoming vehicle.

When the passing-each-other action determination unit 22 determines that the oncoming vehicle has an intention to perform passing-each-other, the evacuation region search unit 23 searches for and determines a region (evacuation region) where the own vehicle waits from the virtual evacuation region map generated by the virtual evacuation region acquisition unit 17.

The route planning unit 24 plans a traveling route (track) from the current position to the region where the own vehicle waits determined by the evacuation region search unit 23.

The vehicle control unit 25 outputs a control command to actuators (not illustrated) of the own vehicle based on the traveling route plan by the route planning unit 24 to control the traveling of the own vehicle.

### [Hardware Configuration of Control System]

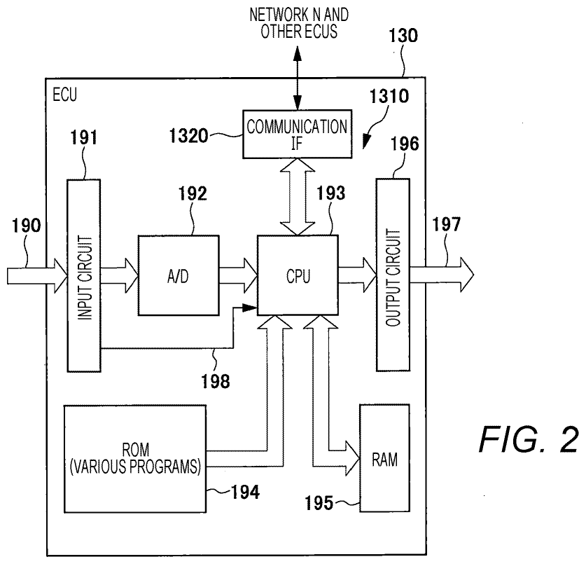

Next, a hardware configuration of a control system of the external world information processing device 10 and the travel control planning device 20 constituting the vehicle control device 1 will be described with reference to FIG. 2.

FIG. 2 is a block diagram illustrating a hardware configuration example of a control system of the external world information processing device 10 and the travel control planning device 20. As illustrated in FIG. 2, the external world information processing device 10 and the travel control planning device 20 include an electronic control device 130. The electronic control device 130 includes an input circuit 191, an A/D converter 192, a CPU (central processing unit) 193 that is a central processing unit, a ROM (read only memory) 194, a RAM (random access memory) 195, an output circuit 196, and a communication IF 1320. For example, an arithmetic processing device 1310 includes an A/D converter 192, a CPU 193, a ROM 194, and a RAM 195.

The CPU 193 develops a program stored in the ROM 194 (an example of a storage unit) in the RAM 195 and executes the program, thereby implementing the functions of the external world information processing device 10 and the travel control planning device 20 according to the embodiment of the present invention. The CPU 193 is an example of a processor. Note that a processor such as a micro-processing unit (MPU) may be used instead of the CPU 193.

The input circuit 191 takes in signals output from the external sensor group 11 and the vehicle sensor group 12 as input signals 190. Examples of the vehicle sensor include an intake flow rate sensor, a throttle sensor, a water temperature sensor, a steering angle sensor, a crank angle sensor, a posture sensor (acceleration sensor, gyro sensor), an intake cam angle sensor, and an exhaust cam angle sensor. When the input signal 190 is an analog signal, the input circuit 191 removes a noise component or the like from the input signal 190, and outputs the noise-removed signal to the A/D converter 192.

The A/D converter 192 converts the analog signal into a digital signal and outputs the digital signal to the CPU 193. The CPU 193 takes in the digital signal output from the A/D converter 192 and executes control logic (program) stored in a storage medium such as the ROM 194 to execute various calculations, controls, and the like.

Note that the calculation result of the CPU 193 and the conversion result of the A/D converter 192 are temporarily stored in the RAM 195. In the present embodiment, as the ROM 194, a nonvolatile memory such as an electrically erasable and programmable read only memory (EEPROM) in which contents can be rewritten may be used. For example, a program in which an algorithm for implementing each function according to the embodiment of the present invention is described may be stored in the ROM 194 or a non-volatile storage (not illustrated). In addition, map data is stored in a non-volatile storage (not illustrated) as an example of environment information, and the map data is used for planning and prediction of a traveling route. Note that the non-volatile storage may be a storage medium detachable from the external world information processing device 10 and the travel control planning device 20, such as a cassette type solid state drive (SSD).

The calculation result of the CPU 193 is output as a control signal 197 from the output circuit 196, and is used for controlling actuators to be controlled. Examples of the control target include an intake valve drive device, an exhaust valve drive device, a fuel injection device, an ignition plug, a steering device, a brake device, and a power conversion circuit.

When the input signal 190 is a digital signal, the input signal 190 is directly transmitted from the input circuit 191 to the CPU 193 via a signal line 198, and the CPU 193 executes necessary calculation, control, and the like.

The communication IF 1320 includes a communication device or the like that controls communication with another device. For example, the communication IF 1320 is a communication device that communicates with a wide area network N (for example, the Internet), or a communication device that communicates with other ECUs, sensors, or the like in the own vehicle by a controller area network (CAN) or the like. The vehicle-to-vehicle communication via the external communication device 30 is realized by the communication IF 1320.

Note that, although the example in which the external world information processing device 10 and the travel control planning device 20 each include the electronic control device 130 has been described, the vehicle control device 1 may include one electronic control device 130. That is, one electronic control device 130 implements each function of the external world information processing device 10 and the travel control planning device 20 in the vehicle control device 1.

### [Example of Passing-Each-Other Traveling Scene]

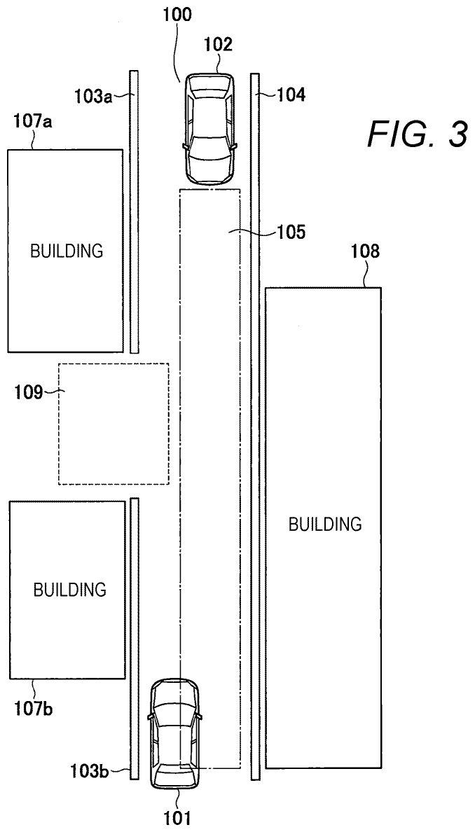

Next, an example of a passing-each-other traveling scene will be described with reference to FIG. 3.

FIG. 3 is a schematic diagram illustrating a situation where passing-each-other traveling is performed with an oncoming vehicle on a narrow path of a single lane as an example of a passing-each-other traveling scene. In FIG. 3, the own vehicle 101 is in a situation where the own vehicle 101 wants to move forward in a single lane 100 surrounded by a structure (for example, walls 103a, 103b, and 104 at the passage end) higher than the own vehicle with the road width that does not allow two vehicles to pass each other at the same time. On the other hand, there is an oncoming vehicle 102 in front of the own vehicle 101, and the oncoming vehicle 102 also wants to move forward like a predicted track 105 indicated by a one-dot chain line. The own vehicle 101 can pass the oncoming vehicle 102 by moving to an evacuation region 109 (a region surrounded by a broken line) between the wall 103a and the wall 103b and waiting.

### [Processing of External World Information Processing Device]

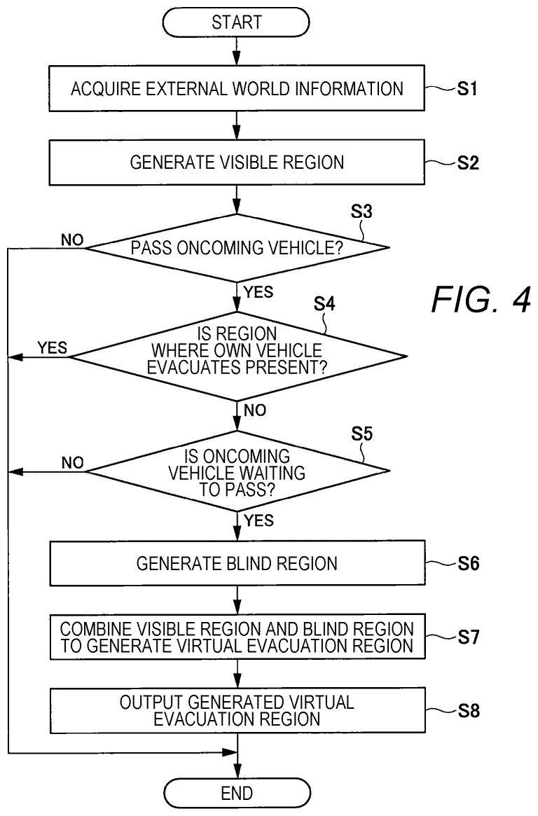

Next, processing of the external world information processing device 10 will be described with reference to FIG. 4.

FIG. 4 is a flowchart illustrating a procedure example of processing of the external world information processing device 10. First, in step S1, the external world information acquisition unit 13 of the external world information processing device 10 acquires an object (for example, oncoming vehicle 102) around the own vehicle 101 and surrounding environment information (for example, the free space) from the own vehicle 101.

Next, in step S2, the visible region acquisition unit 14 generates the visible region map 106 used for the own vehicle 101 to travel from the surrounding environment information obtained from the external world information acquisition unit 13. As an example of an expression form, the visible region map 106 is expressed by a grid-like map (also referred to as a grid map) defined in an x-y coordinate system centered on the current position of the own vehicle 101.

### [Example of Visible Region Map]

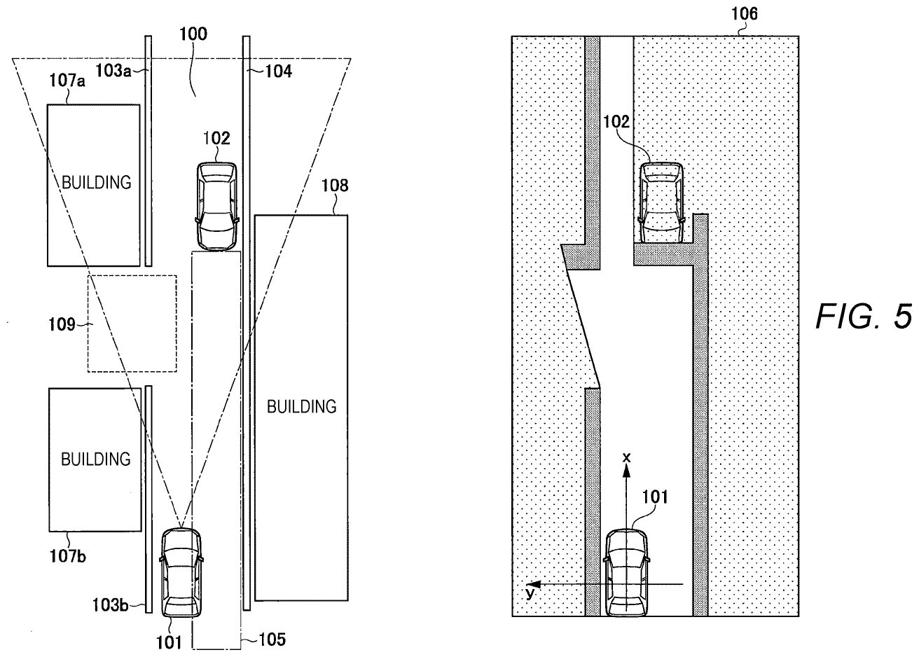

Here, the visible region map 106 will be described with reference to FIG. 5.

FIG. 5 is a schematic diagram illustrating an example of the visible region map 106. The left side of FIG. 5 is obtained by adding a one-dot chain line triangle representing the visual field of the external sensor to the content of FIG. 3, and the right side of FIG. 5 illustrates an example of the visible region map 106. However, in FIG. 5, the oncoming vehicle 102 moves forward and is at a position where the distance from the own vehicle 101 is slightly reduced. Note that the viewing angle (measurement range) of the external sensor represented by a triangle is an example, and is not limited to this example.

In the example on the right side of FIG. 5, a road boundary (for example, walls 103a, 103b, and 104) which is a stationary object, buildings 107a, 107b, and 108, and an oncoming vehicle 102 which is a moving object are indicated in dark gray as the presence of an obstacle. An invisible region that is a blind spot from the own vehicle 101 due to an obstacle, that is, a region that cannot be directly recognized from the own vehicle 101 is indicated in light gray. A region where the obstacle (dark gray) and the invisible region (light gray) do not exist is indicated by (white) as a region (free space) where the own vehicle 101 can travel.

The description returns to the flowchart of FIG. 4. Next, in step S3, the passing-each-other action determination unit 22 determines, from the visible region map 106 and the state of the oncoming vehicle 102, whether or not the oncoming vehicle 102 intends to perform the passing-each-other action. The passing-each-other action determination unit 22 determines that the oncoming vehicle 102 moves forward from the result of predicting the predicted track 105 of the oncoming vehicle 102 by the oncoming vehicle predicted route acquisition unit 21, and determines that passing-each-other with the own vehicle 101 is necessary. When vehicle-to-vehicle communication is performed with the oncoming vehicle 102 via the external communication device 30, the passing-each-other action determination unit 22 may receive information indicating an intention to perform the passing-each-other action from the oncoming vehicle 102. In addition, the sign from the headlight of the oncoming vehicle 102 may be recognized by the external world information acquisition unit 13, and it may be determined that the oncoming vehicle 102 has an intention of the passing-each-other action.

Next, when the passing-each-other action determination unit 22 determines that the oncoming vehicle 102 has an intention of the passing-each-other action (YES determination in S3), the evacuation region search unit 23 searches for an evacuation region where the own vehicle 101 passes the oncoming vehicle 102 and determines whether or not there is an evacuation region in step S4. When the oncoming vehicle 102 does not have the intention of the passing-each-other action (NO determination in S3), this processing ends.

[Example of Scene where Passing-Each-Other is Impossible]

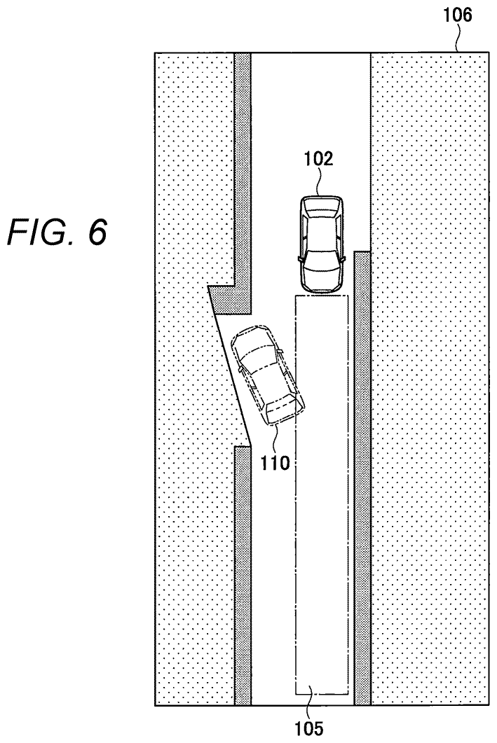

Here, an example of a traveling scene where passing-each-other is impossible will be described with reference to FIG. 6.

FIG. 6 is a schematic diagram illustrating an example of a scene where passing-each-other is impossible. An evacuation position 110 is a part of the evacuation region 109 in FIG. 3 which is an evacuation area when viewed from the own vehicle 101 illustrated on the left side of FIG. 5. The own vehicle 101 recognizes the evacuation position 110 of a part of the evacuation region 109 as a travelable region.

When the evacuation position for passing each other with respect to the predicted track 105 of the oncoming vehicle 102 is the evacuation position 110 illustrated in FIG. 6, the two vehicles cannot pass each other because the rear right side of the own vehicle 101 comes into contact with the oncoming vehicle 102. In such a situation, the evacuation region search unit 23 determines that the own vehicle 101 and the oncoming vehicle 102 cannot pass each other and there is no evacuation region for the own vehicle 101 (NO determination in S4). When there is an evacuation region of the own vehicle 101 (YES determination in S4), this processing ends.

The description returns to the flowchart of FIG. 4. Next, when the evacuation region search unit 23 determines that passing-each-other is impossible (NO determination in S4), in step S5, the oncoming vehicle state determination unit 15 determines whether or not the oncoming vehicle 102 is in a standby state for cooperative action (passing-each-other) with the own vehicle 101 on the basis of the oncoming vehicle information obtained from the external world information acquisition unit 13.

### [Processing of Oncoming Vehicle State Determination Unit]

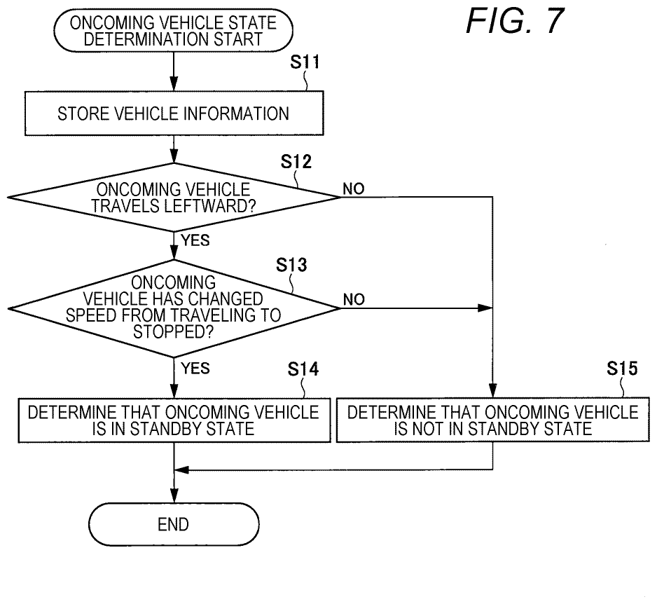

Here, the processing (S5) of the oncoming vehicle state determination unit 15 will be described with reference to the flowchart of FIG. 7.

FIG. 7 is a flowchart illustrating an example of a procedure example of processing of the oncoming vehicle state determination unit 15. First, in step S11, the oncoming vehicle state determination unit 15 stores vehicle information of the oncoming vehicle 102, and stores the vehicle information as history information for a certain period of time. For example, the vehicle information of the oncoming vehicle 102 is information related to the behavior of the oncoming vehicle 102, and is, for example, the vehicle speed, the position, the posture, and the like of the oncoming vehicle 102. The oncoming vehicle state determination unit 15 can determine whether or not the state of the oncoming vehicle 102 is the standby state on the basis of at least history information of the speed of the oncoming vehicle 102 and history information of the position of the oncoming vehicle 102 among the information regarding the behavior of the oncoming vehicle 102. The standby state (stop) of the oncoming vehicle 102 can be determined from at least the history information of the speed and the position of the oncoming vehicle 102.

Next, in step S12, the oncoming vehicle state determination unit 15 determines whether or not the oncoming vehicle 102 is not traveling in the center between the walls 103a and 103b and the wall 104 on the road center but traveling closer to the wall 104 (left side). Driving on the left side of the road is also called “keep-left-traveling”. The form of the keep-left-traveling includes a case where the vehicle is originally in the keep-left-traveling, a case where the vehicle transitions from the center traveling to the keep-left-traveling during traveling, a case where the oncoming vehicle 102 is in the keep-left-traveling after recognizing the oncoming vehicle (that is, the own vehicle 101), or the like. The oncoming vehicle state determination unit 15 can determine that the oncoming vehicle 102 has changed from other than the keep-left-traveling to the keep-left-traveling on the basis of the past relative position information included in the vehicle information of the oncoming vehicle 102 in step S11. If YES is determined in step S12, the processing proceeds to the determination processing in step S13.

In step S13, the oncoming vehicle state determination unit 15 determines whether or not the speed of the oncoming vehicle 102 has been changed from “traveling” to “stopped” on the basis of the past speed information included in the vehicle information of the oncoming vehicle 102 in step S11.

In step S14, in a case where it is determined in step S12 that the oncoming vehicle 102 is in the keep-left-traveling (YES determination in S12), and in a case where it is determined in step S13 that the speed of the oncoming vehicle 102 has changed from “traveling” to “stopped” (YES determination in S13), the oncoming vehicle state determination unit 15 determines that the oncoming vehicle 102 is in a standby state. Step S14 corresponds to the YES determination in step S5 in FIG. 4.

In addition, in step S15, in a case where it is determined in step S12 that the oncoming vehicle 102 is not in the keep-left-traveling (NO determination in S12), or in a case where it is determined in step S13 that the speed of the oncoming vehicle 102 has not changed from “traveling” to “stopped” (NO determination in S13), the oncoming vehicle state determination unit 15 determines that the oncoming vehicle 102 is in a state other than the standby state. In this case, for example, the oncoming vehicle 102 can be determined to be in a state of right turn or left turn traveling, or on-road parking. Step S15 corresponds to the NO determination in step S5 of FIG. 4, and ends the processing of the external world information processing device 10 illustrated in FIG. 4.

In step S6 of FIG. 4, in a case where the oncoming vehicle state determination unit 15 determines that the oncoming vehicle 102 is in the standby state (YES determination in S5), the blind region acquisition unit 16 generates a blind region estimated as a temporary visible region (travelable region where the own vehicle 101 can travel).

### [Example of Blind Region]

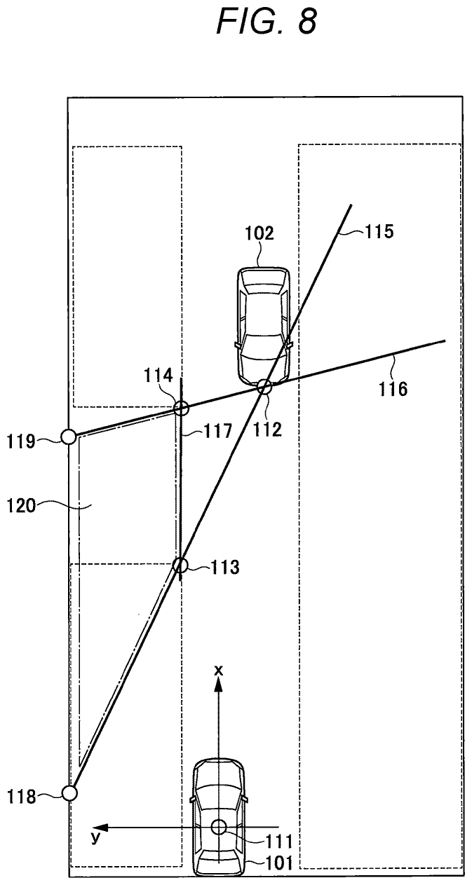

Here, generation processing (S6) of the blind region by the blind region acquisition unit 16 will be described with reference to FIG. 8.

FIG. 8 is a diagram illustrating an example of a blind region acquired by the blind region acquisition unit 16. FIG. 8 illustrates an example in which a blind region 120 (trapezoidal portion indicated by an alternate long and short dash line) that cannot be directly recognized from the own vehicle 101 is generated in the passing-each-other traveling scene illustrated in FIG. 5. In FIG. 8, a region indicated by a broken line is a region where the vehicle cannot travel due to walls 103a, 103b, and 104, buildings 107a, 107b, and 108, and the like.

The blind region acquisition unit 16 sets, in the visible region map 106 output from the visible region acquisition unit 14, an own vehicle coordinate 111 having a coordinate system in which one point (for example, the center) of the own vehicle 101 is an origin, the front of the own vehicle is x, and the left direction of the own vehicle is y. Then, the blind region acquisition unit 16 acquires an oncoming vehicle coordinate 112 indicating the position of the oncoming vehicle 102, a start point edge coordinate 113, and an end point edge coordinate 114 with respect to the own vehicle coordinate 111 on the visible region map 106.

The start point edge coordinate 113 is an edge or an end of an obstacle (the wall 103b on the right side in FIG. 5) and a blind region (light gray on the wall 103b side) close to the own vehicle coordinate 111 where the y axis of the own vehicle coordinate 111 exists in the positive direction (left side in FIG. 5). In other words, the start point edge coordinate 113 is a coordinate (an example of a blind viewpoint position) at the boundary between the end of the obstacle (dark gray: wall 103b) close to the own vehicle coordinate 111 and the blind region (light gray).

The end point edge coordinate 114 is an edge or an end of an obstacle (the wall 103b on the right side in FIG. 5) and a blind region (light gray on the wall 103b side) close to the oncoming vehicle coordinate 112 with the y axis of the own vehicle coordinate 111 existing in the positive direction (left side in FIG. 5). In other words, the end point edge coordinate 114 is a coordinate (an example of a blind end point position) at the boundary between the blind region (light gray) and the end of the obstacle (dark gray, wall 103a) farther from the own vehicle coordinate 111 than the obstacle (dark gray: wall 103b).

In addition, the blind region acquisition unit 16 generates a start point-oncoming vehicle straight line 115, an end point-oncoming vehicle straight line 116, and a start point-end point straight line 117. The start point-oncoming vehicle straight line 115 is a straight line passing through the oncoming vehicle coordinate 112 and the start point edge coordinate 113. The end point-oncoming vehicle straight line 116 is a straight line passing through the oncoming vehicle coordinate 112 and the end point edge coordinate 114. The start point-end point straight line 117 is a straight line passing through the start point edge coordinate 113 and the end point edge coordinate 114.

In addition, the blind region acquisition unit 16 calculates a start point termination coordinate 118 and an end point termination coordinate 119. The start point termination coordinate 118 is a coordinate of an end portion of the grid-like map (corresponding to the visible region map 106) located on the start point-oncoming vehicle straight line 115 and in the positive direction of the y axis (left side in the drawing) from the start point edge coordinate 113. The end point termination coordinate 119 is a coordinate of an end portion of the grid-like map (corresponding to the visible region map 106) located on the end point-oncoming vehicle straight line 116 and in the positive direction of the y axis (left side in the drawing) from the end point edge coordinate 114.

As described above, the blind region acquisition unit 16 connects the position of the oncoming vehicle 102 (oncoming vehicle coordinate 112) and a blind start point position (start point edge coordinates 113) by the straight line (start point-oncoming vehicle straight line 115), and uses information from the blind start point position to the termination of the visible region (start point termination coordinate 118) on the opposite side of the position of the oncoming vehicle across the blind start point position on the straight line.

In addition, the blind region acquisition unit 16 connects the position (oncoming vehicle coordinate 112) of the oncoming vehicle 102 and the blind end point position (end point edge coordinate 114) by a straight line (end point-oncoming vehicle straight line 116), and uses information from the blind end point position to the termination (end point termination coordinate 119) of the visible region on the opposite side of the position of the oncoming vehicle across the blind end point position on the straight line.

Then, the blind region acquisition unit 16 sets, as a blind region (blind region 120), a region obtained by connecting, by line segments, a blind start point position (start point edge coordinate 113), a blind end point position (end point edge coordinate 114), a termination (start point termination coordinate 118) of the visible region on a straight line (start point-oncoming vehicle straight line 115) connecting the position of the oncoming vehicle 102 and the blind start point position, and a termination (end point termination coordinate 119) of the visible region on a straight line (end point-oncoming vehicle straight line 116) connecting the position of the oncoming vehicle 102 and the blind end point position.

As described above, the blind region acquisition unit 16 can use the position of the oncoming vehicle 102, the blind start point position that is the position of the boundary between the end of the obstacle closer to the own vehicle 101 and the blind spot of the own vehicle in the visible region (visible region map 106), and the blind end point position that is the position of the boundary between the end of the obstacle farther from the own vehicle than the obstacle and the blind spot of the own vehicle, to generate the closed blind region 120, thereby being able to use the closed blind region as a temporary visible region of the own vehicle 101.

Then, the blind region acquisition unit 16 generates, as the blind region 120, a region connecting the start point edge coordinate 113, the end point edge coordinate 114, the start point termination coordinate 118, and the end point termination coordinate 119. As with the visible region map 106 by the visible region acquisition unit 14, the blind region 120 is represented by a grid-like map (grid map) defined in an x-y coordinate system centered on the current position of the own vehicle 101.

The description returns to the flowchart of FIG. 4. In step S7, the virtual evacuation region acquisition unit 17 combines the blind region 120 generated by the blind region acquisition unit 16 and the visible region map 106 (travelable region) generated by the visible region acquisition unit 14 to generate a virtual evacuation region map.

### [Virtual Evacuation Region Map]

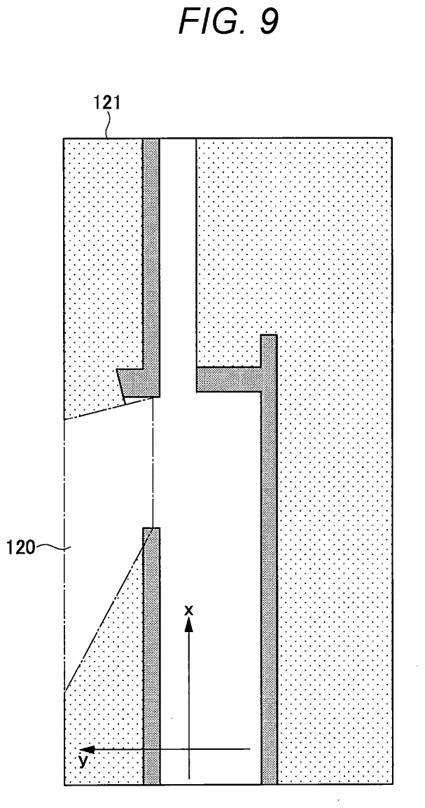

Here, generation processing (S7) of the virtual evacuation region map of the virtual evacuation region acquisition unit 17 will be described with reference to FIG. 9.

FIG. 9 is a schematic diagram illustrating an example of a virtual evacuation region map acquired by the virtual evacuation region acquisition unit 17. FIG. 9 illustrates an example of a virtual evacuation region map 121 in which the blind region 120 (FIG. 8) generated by the blind region acquisition unit 16 is combined with the visible region map 106 (right side in FIG. 5) generated by the visible region acquisition unit 14.

As with the visible region map 106 output from the visible region acquisition unit 14, the virtual evacuation region map 121 is expressed by a grid-like map (grid map) defined in an x-y coordinate system with the current position of the own vehicle 101 as the center (origin).

In the combining of the grid-like maps, priority is given to an obstacle (dark gray) over an invisible region (light gray) and a visible region (white). That is, the obstacle (dark gray) is not overwritten with the invisible region (light gray) or the visible region (white). In the invisible region (light gray) and the visible region (white), the visible region (white) is prioritized. As an example, in a case where the blind region 120 (invisible region) is combined with the visible region map 160, the combining is performed such that an obstacle (dark gray) remains in a portion where the obstacle (dark gray) overlaps with the invisible region (light gray) or the visible region (white). In addition, in a portion where the invisible region (light gray) and the visible region (white) overlap, combining is performed such that the visible region (white) remains.

In this manner, the virtual evacuation region acquisition unit (the virtual evacuation region acquisition unit 17) overlaps the visible region (the visible region map 106) obtained from the visible region acquisition unit 14 and the blind region (the blind region 120) obtained from the blind region acquisition unit 16, and generates the virtual evacuation region (the virtual evacuation region map 121) by setting the region that is a blind region in the visible region as the visible region (white) from the result of the blind region.

With such processing, the blind region from the own vehicle is converted into a virtual evacuation region (temporary visible region) where the own vehicle can evacuate, whereby the visible region where the own vehicle can travel can be expanded.

The description returns to the flowchart of FIG. 4. In step S8, the external world information processing device 10 transmits, as information on the temporary visible region, the virtual evacuation region map 121 generated in step S7 from the virtual evacuation region acquisition unit 17 to the evacuation region search unit 23 of the travel control planning device 20. After step S8 ends, the present processing by the external world information processing device 10 ends.

In the travel control planning device 20, when the oncoming vehicle 102 is in a standby state, the evacuation region search unit 23 acquires the virtual evacuation region map 121 from the virtual evacuation region acquisition unit 17 and searches for an evacuation region. The evacuation region search unit 23 detects the blind region 120 of the virtual evacuation region map 121 as a region that can be used for evacuation (evacuation region). Next, the route planning unit 24 plans a traveling route from the current position of the own vehicle 101 to the evacuation region detected by the evacuation region search unit 23. Then, the vehicle control unit 25 controls traveling of the own vehicle 101 based on the traveling route plan.

As described above, the external world information processing device (external world information processing device 10) according to the present embodiment includes: an external world information acquisition unit (external world information acquisition unit 13) that acquires external world information around the own vehicle on the basis of a result recognized by an external world recognition unit (external sensor group 11); a visible region acquisition unit (visible region acquisition unit 14) that acquires a visible region as a travelable region visible from the own vehicle on the basis of the external world information; an oncoming vehicle state determination unit (oncoming vehicle state determination unit 15) that determines a state of an oncoming vehicle on the basis of the visible region and information regarding behavior of the oncoming vehicle; a blind region acquisition unit (blind region acquisition unit 16) that acquires a blind region that is a blind spot of the own vehicle on the basis of the state of the oncoming vehicle, the visible region, and a position of the oncoming vehicle acquired on the basis of the external world information; and a virtual evacuation region acquisition unit (virtual evacuation region acquisition unit 17) that acquires a virtual evacuation region for the own vehicle and the oncoming vehicle to pass each other based on the visible region and the blind region.

In the external world information processing device according to the present embodiment configured as described above, in a case where there is no region where the own vehicle evacuates in a passing-each-other traveling scene with the oncoming vehicle, it is detected that the oncoming vehicle is standing by, and information on the position of the oncoming vehicle, and the obstacle on the left side facing the own vehicle and the edge of the visible region is obtained. As a result, a blind region from the own vehicle can be generated in a region where the own vehicle can evacuate.

According to this embodiment, when the own vehicle cannot find the evacuation region in a situation where the own vehicle and the oncoming vehicle are required to pass each other, it is possible to estimate the evacuation region and smoothly perform the passing-each-other action without causing a deadlock state with the oncoming vehicle.

In the present embodiment, in a case where the oncoming vehicle state determination unit 15 is in the standby state, the blind region 120 and the virtual evacuation region map 121 are generated. However, the blind region 120 and the virtual evacuation region map 121 may be always generated. In a case where the blind region 120 is not generated, combining is performed assuming that there is no region of the blind region 120, and the virtual evacuation region map 121 is generated. Therefore, this is similar to the visible region map 106, and does not hinder other functions.

In addition, in step S5 of the present embodiment, in a case where the oncoming vehicle 102 is parked on the road instead of being in a standby state for passing each other, the own vehicle 101 cannot travel. Therefore, it is desirable that the own vehicle 101 moves backward as another means to change the traveling route or notifies the driver of the own vehicle 101 that traveling is impossible.

In addition, after the virtual evacuation region map 121 is generated, in a case where it is detected that the size of the evacuation region is not sufficient when the own vehicle 101 approaches the blind region 120, the own vehicle 101 may move backward to change the traveling route, or the oncoming vehicle 102 may be requested to move backward by vehicle-to-vehicle communication.

In addition, in the present embodiment, it is assumed that there is an evacuation region of the own vehicle 101 on the left side of the road, but it may be considered that there is an evacuation region on the side where traveling is determined by a national law that manages the road on which the vehicle travels. For example, in the above-described example, an example has been described in which there is an evacuation region on the left side of the road on the assumption of traveling on the left side. However, in a case where right-side traffic is prescribed by law, the evacuation region is searched on the right side of the road.

### Second Embodiment

In the external world information processing device 10 according to the first embodiment described above, the visible region map 106, the blind region 120, and the virtual evacuation region map 121 are generated on the basis of information from the external sensor group 11. On the other hand, in a second embodiment of the present invention, an external world information processing device that generates a blind region and a virtual evacuation region map from information obtained by the external communication device 30 will be described.

### [Configuration of Vehicle Control Device (External World Information Processing Device)]

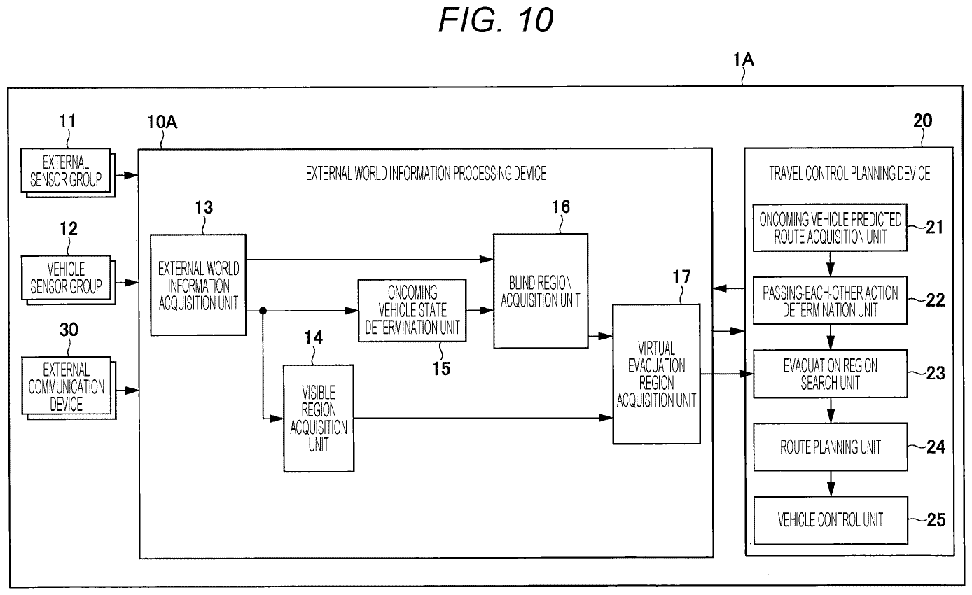

FIG. 10 is a block diagram illustrating a functional configuration example of a vehicle control device including an external world information processing device according to the second embodiment. A vehicle control device 1A according to the second embodiment includes an external world information processing device 10A instead of the external world information processing device 10 in the vehicle control device 1 (FIG. 1) according to the first embodiment. The external world information processing device 10A of the present embodiment is different from the external world information processing device 10 of the first embodiment in that the input of the blind region acquisition unit 16 is not information from the oncoming vehicle state determination unit 15 and the visible region acquisition unit 14, but information from the oncoming vehicle state determination unit 15 and the external world information acquisition unit 13.

As described in the first embodiment, the external world information acquisition unit 13 acquires information detected in the other vehicle from the other vehicle by vehicle-to-vehicle communication (communication between the own vehicle and the other vehicle) by wireless communication using the external communication device 30 in addition to the external sensor group 11.

### [Processing of Vehicle Control Device]

The processing of the vehicle control device 1A in the present embodiment is processing similar to the flowchart illustrated in FIG. 4. However, the processing of the external world information acquisition unit 13 of the external world information processing device 10A in step S1, the processing of the blind region acquisition unit 16 in step S6, and the processing of the virtual evacuation region acquisition unit 17 in step S7 are different. Hereinafter, for the processing of the vehicle control device 1A, a passing-each-other traveling scene will be described assuming a scene similar to that in FIG. 5 in the first embodiment.

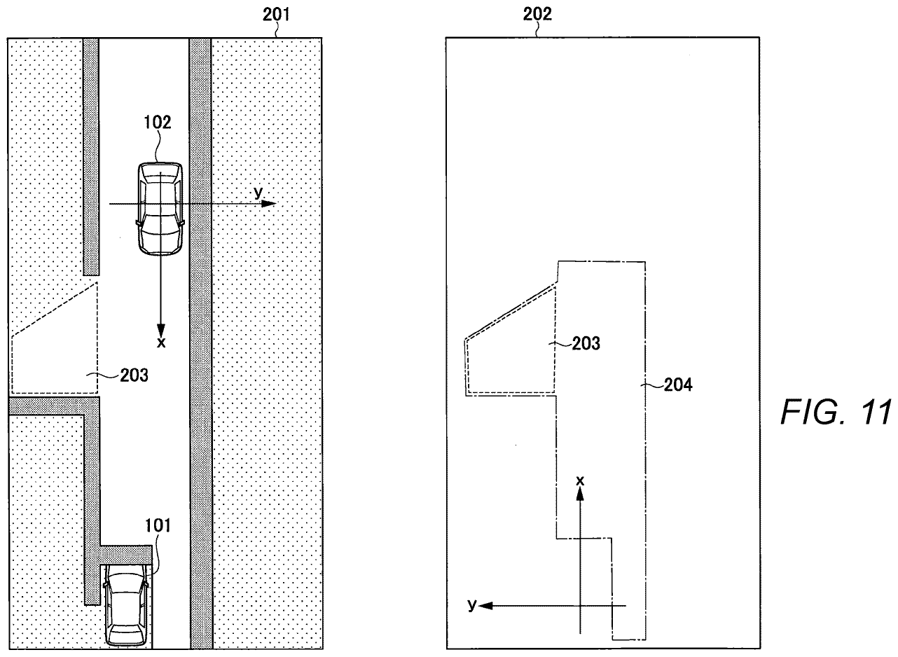

In step S1, the external world information acquisition unit 13 acquires objects (for example, oncoming vehicle 102) around the own vehicle 101 and surrounding environment information (for example, the free space) from the own vehicle 101. In addition, the external world information acquisition unit 13 acquires a visible region map 201 (see FIG. 11 described later) of the oncoming vehicle 102 by vehicle-to-vehicle communication with the oncoming vehicle 102.

At this time, the visible region and the blind region of the oncoming vehicle 102 are represented by a grid-like map (grid map) defined in an x-y coordinate system centered on the current position of the oncoming vehicle 102. Therefore, in a case where the acquired visible region and blind region of the oncoming vehicle 102 are not a grid-like map defined in the x-y coordinate system centered on the own vehicle 101, it is desirable to perform conversion into the x-y coordinate system centered on the own vehicle 101.

Next, in steps S2 to S5, the vehicle control device 1A executes processing similar to that of the first embodiment.

Next, in step S6, in a case where the oncoming vehicle state determination unit 15 determines that the oncoming vehicle 102 is in the standby state (YES determination in S5), the blind region acquisition unit 16 acquires the visible region map 201 of the oncoming vehicle 102 from the external world information acquisition unit 13.

### [Processing of Blind Region Acquisition Unit]

FIG. 11 is a diagram illustrating an example in which the blind region acquisition unit 16 of the external world information processing device 10A acquires a blind region map on the basis of a travelable region recognized by the oncoming vehicle. The left side of FIG. 11 is an example of the visible region map 201 (grid-like map) acquired from the oncoming vehicle 102. The right side of FIG. 11 is an example of the acquired blind region map 202.

Since the oncoming vehicle 102 recognizes the surroundings from a viewpoint different from that of the own vehicle 101, a visible region 203 (left side in FIG. 11) indicated by a broken line in the visible region map 201 can be recognized more widely than the own vehicle 101. Since the region where the oncoming vehicle 102 can travel includes a region that is a blind spot from the own vehicle 101, the blind region acquisition unit 16 converts the coordinates of the region 204 (right side in FIG. 11) where the oncoming vehicle 102 can travel from the front into the coordinate system with the own vehicle 101 as the origin, and generates the blind region map 202.

Next, in step S7 of FIG. 4, the virtual evacuation region acquisition unit 17 combines the blind region map 202 generated by the blind region acquisition unit 16 and the visible region map 106 (travelable region) on the right side of FIG. 5 generated by the visible region acquisition unit 14 to generate a virtual evacuation region map.

### [Virtual Evacuation Region Map]

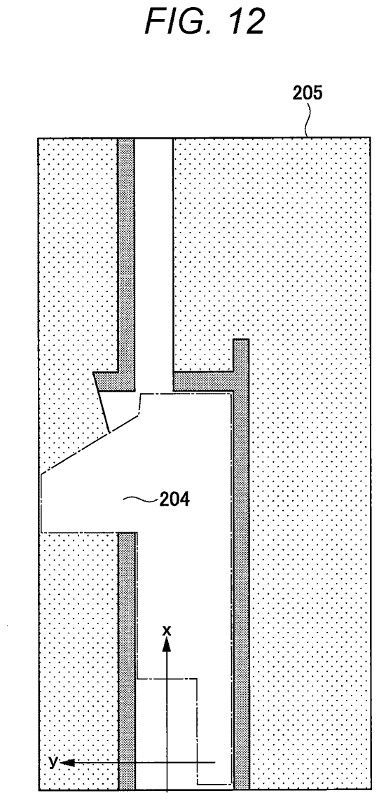

FIG. 12 is a schematic diagram illustrating an example of a virtual evacuation region map acquired by the virtual evacuation region acquisition unit 17 of the external world information processing device 10A. FIG. 12 illustrates an example of a virtual evacuation region map 205 obtained by combining the visible region map 106 (right side in FIG. 5) generated by the visible region acquisition unit 14 with the blind region map 202 (right side in FIG. 11) generated by the blind region acquisition unit 16. In a case where the blind region map 202 is combined with the visible region map 106, the obstacle (dark gray) is not erased as in the first embodiment.

Next, in step S8 of FIG. 4, the external world information processing device 10A transmits the virtual evacuation region map 205 generated in step S7 to the evacuation region search unit 23 of the travel control planning device 20 from the virtual evacuation region acquisition unit 17 as information on the visible region. After step S8 ends, the present processing by the external world information processing device 10A ends.

As described above, in the external world information processing device according to the present embodiment, when obtaining the blind region, the blind region acquisition unit (blind region acquisition unit 16) acquires the visible region (visible region map 201) of the oncoming vehicle from the oncoming vehicle by the external communication device (external communication device 30) mounted on the own vehicle, and replaces the blind region, which is the blind spot of the own vehicle, with the visible region (visible region 203) of the oncoming vehicle to generate the virtual evacuation region (virtual evacuation region map 205).

As described above, by combining the visible region information (visible region 203) of the oncoming vehicle with the visible region information (visible region map 106) of the own vehicle, it is possible to set the blind region (light gray) from the own vehicle as the visible region (white).

### Third Embodiment

As a third embodiment of the present invention, an example will be described in which the visible region is enlarged by moving the own vehicle when it is difficult to see the evacuation region from the own vehicle. The vehicle control device (external world information processing device) according to the present embodiment has the same configuration as the vehicle control device 1 according to the first embodiment or the vehicle control device 1A according to the second embodiment.

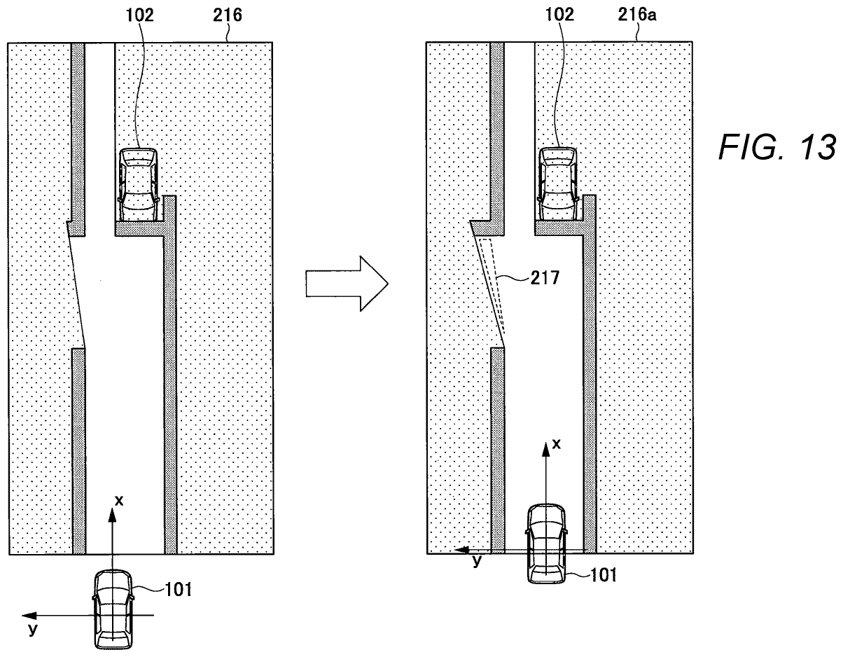

FIG. 13 is a schematic diagram illustrating a countermeasure example in a case where the blind region acquisition unit 16 (FIG. 1, FIG. 10) of the external world information processing device according third embodiment cannot acquire the blind region. The left side of FIG. 13 is an example of the visible region map 216 in a case where the own vehicle 101 is far from the evacuation region 109 (FIG. 3) and it is difficult to see the evacuation region 109. The right side of FIG. 13 is an example of a visible region map 216a in which the own vehicle 101 moves and the visible region is enlarged when the oncoming vehicle 102 is waiting.

In a case where the blind region according to the first embodiment or the second embodiment cannot be acquired, the blind region acquisition unit 16 of the external world information processing device outputs a control command for moving the own vehicle 101 so as to enlarge the visible region to the route planning unit 24 of the travel control planning device 20. The route planning unit 24 receives a control command from the blind region acquisition unit 16 and instructs the vehicle control unit 25 to move the own vehicle 101.

In the visible region map 216 on the left side of FIG. 13, in a case where the own vehicle 101 is far from the evacuation region 109 and the evacuation region 109 cannot be seen, but the oncoming vehicle 102 is waiting, the own vehicle 101 moves (for example, moves forward while moving to the center of the road) to enlarge the visible region. In the visible region map 216a on the right side of FIG. 13, the visible region is enlarged by the visible region 217 by the forward movement of the own vehicle 101. As an example, the blind region acquisition unit 16 performs control to move the own vehicle 101 until it can be confirmed that a travelable region having a size equal to or larger than a size necessary for evacuation exists in a portion corresponding to the target blind region.

As described above, in a case where the blind region cannot be acquired, the blind region acquisition unit 16 can reduce the region that becomes the blind spot from the own vehicle and enlarge the visible region by moving the own vehicle in the direction of the region that becomes the blind spot.

### <Modification>

Note that, in the above-described embodiment, an example in which the visible region, the blind region, and the evacuation region are expressed by a grid-like map has been described. However, an expression for specifying the blind region may be expressed with respect to detection information depending on a detection range such as an angle and a distance of the external sensor group 11. The detection range of the external sensor group 11 may be defined by the height in addition to the angle and the distance. In addition, depending on the type of the external sensor, a sensor result of detecting the reflectance, the color, or the blind spot of the electromagnetic wave is also assumed.

In addition, the present invention is not limited to the above-described embodiments, and it goes without saying that various other application examples and modifications can be taken without departing from the gist of the present invention described in the claims. For example, the above-described embodiments have described the configurations specifically and in detail for easy understanding of the present invention, and the present invention is not necessarily limited to those having all the described components. In addition, it is also possible to add, replace, or delete other components for a part of the configuration of each embodiment.

In addition, some or all of the above-described configurations, functions, processing units, and the like may be realized by hardware, for example, by designing with an integrated circuit. A processor device in a broad sense such as an FPGA (Field Programmable Gate Array) or an ASIC (Application Specific Integrated Circuit) may be used as the hardware.

In addition, in the above-described embodiment, the control lines and the information lines indicate what is considered to be necessary for the description, and do not necessarily indicate all the control lines and the information lines necessary on the product. In practice, it may be considered that almost all the components are mutually connected.

Furthermore, in the present specification, the processing steps the time-series processing include not only processing performed in time series according to the described order, but also processing that is not necessarily performed in time series and is executed in parallel or individually (for example, processing by an object). Furthermore, the processing order of the processing steps describing the time-series processing may be changed within a range not affecting the processing result.

### REFERENCE SIGNS LIST

1, 1A vehicle control device
10, 10A external world information processing device
10A external world information processing device
11 external sensor group
12 vehicle sensor group
13 external world information acquisition unit
14 visible region acquisition unit
15 oncoming vehicle state determination unit
16 blind region acquisition unit
17 virtual evacuation region acquisition unit
20 travel control planning device
30 external communication device
101 own vehicle
102 oncoming vehicle
106 visible region map
109 evacuation region
111 own vehicle coordinate
112 oncoming vehicle coordinate
113 start point edge coordinate
114 end point edge coordinate
115 start point-oncoming vehicle straight line
116 end point-oncoming vehicle straight line
117 start point-end point straight line
118 start point termination coordinate
119 end point termination coordinate
120 blind region
121 virtual evacuation region map
130 electronic control device

1. An external world information processing device, comprising:
an external world information acquisition unit that acquires external world information around an own vehicle on a basis of a result recognized by an external world recognition unit;
a visible region acquisition unit that acquires a visible region as a travelable region visible from the own vehicle on a basis of the external world information;
an oncoming vehicle state determination unit that determines a state of the oncoming vehicle on a basis of the visible region and information on a behavior of the oncoming vehicle;
a blind region acquisition unit that acquires a blind region that is a blind region of the own vehicle on a basis of the state of the oncoming vehicle, the visible region, and a position of the oncoming vehicle acquired based on the external world information; and
a virtual evacuation region acquisition unit that acquires a virtual evacuation region for the own vehicle and the oncoming vehicle to pass each other based on the visible region and the blind region.

2. The external world information processing device according to claim 1, wherein
the oncoming vehicle state determination unit determines whether or not a state of the oncoming vehicle is a standby state on a basis of history information of a speed of the oncoming vehicle and history information of a position of the oncoming vehicle among the information regarding a behavior of the oncoming vehicle, and
the blind region acquisition unit generates the blind region when the state of the oncoming vehicle is a standby state.

3. The external world information processing device according to claim 1, wherein the blind region acquisition unit, when obtaining the blind region, uses a position of the oncoming vehicle, a blind start point position that is a position of a boundary between an end of an obstacle close to the own vehicle and the blind spot of the own vehicle in the visible region, and a blind end point position that is a position of a boundary between an end of an obstacle farther from the own vehicle than the obstacle and the blind spot of the own vehicle.

4. The external world information processing device according to claim 3, wherein the blind region acquisition unit connects the position of the oncoming vehicle and the blind start point position by a straight line, and uses information from the blind start point position to a termination of the visible region on an opposite side of the position of the oncoming vehicle across the blind start point position on the straight line.

5. The external world information processing device according to claim 3, wherein the blind region acquisition unit connects the position of the oncoming vehicle and the blind end point position by a straight line, and uses information from the blind end point position to a termination of the visible region on an opposite side of the position of the oncoming vehicle across the blind end point position on the straight line.

6. The external world information processing device according to claim 4, wherein the blind region acquisition unit sets, as the blind region, a region in which the blind start point position, the blind end point position, a termination of the visible region on a straight line connecting the position of the oncoming vehicle and the blind start point position, and a termination of the visible region on a straight line connecting the position of the oncoming vehicle and the blind end point position are connected by line segments.

7. The external world information processing device according to claim 1, wherein the virtual evacuation region acquisition unit overlaps a visible region obtained from the visible region acquisition unit and a blind region obtained from the blind region acquisition unit, and generates the virtual evacuation region by setting a region that is a blind spot in the visible region as a visible region from a result of the blind region.

8. The external world information processing device according to claim 1, wherein the information on a behavior of the oncoming vehicle is acquired on a basis of the external world information.

9. The external world information processing device according to claim 1, wherein the blind region acquisition unit, when obtaining the blind region, acquires a visible region of the oncoming vehicle from the oncoming vehicle by an external communication device mounted on the own vehicle, and replaces the blind region, which is a blind spot of the own vehicle, with the visible region of the oncoming vehicle to generate the virtual evacuation region.

10. An external world information processing method executed by an external world information processing device mounted on an own vehicle, the external world information processing method comprising:
processing of acquiring external world information around the own vehicle on a basis of a result recognized by an external world recognition unit;
processing of acquiring a visible region as a travelable region visible from the own vehicle on a basis of the external world information;
processing of determining a state of the oncoming vehicle on a basis of the visible region and information on a behavior of the oncoming vehicle;
processing of acquiring a blind region that is a blind spot of the own vehicle on a basis of a state of the oncoming vehicle, the visible region, and a position of the oncoming vehicle acquired based on the external world information; and
processing of acquiring a virtual evacuation region for the own vehicle and the oncoming vehicle to pass each other based on the visible region and the blind region.
